(19) United States
(12) Patent Application Publication
(10) Pub. No.: US 2016/0299565 A1
(43) Pub. Date: Oct. 13, 2016

(54) EYE TRACKING FOR REGISTRATION OF A HAPTIC DEVICE WITH A HOLOGRAPH

(71) Applicant: Siemens Aktiengesellschaft, Munich (DE)

(72) Inventor: Sandra Sudarsky, Bedminster, NJ (US)

(21) Appl. No.: 14/680,085

(22) Filed: Apr. 7, 2015

(51) Int. Cl. G06F 3/01; H04N 5/225

(52) U.S. Cl. CPC G06F 3/013; G06F 3/016; H04N 5/225

(57) ABSTRACT

An object or haptic device is registered with a holograph. The position of the object or haptic device relative to the projector or holographic image is sensed. An eye tracking system acts as an additional source of information about the position. As a viewer interacts with the holograph, their eyes focus on the location of interaction. The eye tracking, such as the focal location, provides an additional source of position information to reduce or avoid misregistration.

### BACKGROUND

The present embodiments relate to holographic imaging. Holography is a diffraction-based imaging technique in which three-dimensional (3D) objects are reproduced by light wave patterns. Holographic projection generates a holographic image in three-dimensional space and may enhance the way humans view and manipulate objects and information. Holography may provide advantages for education, entertainment, medical imaging, telepresence, digital advertising, scientific visualization, computer aided design, or other subjects.

Compared to other interactive 3D imaging techniques that render to a two-dimensional display, holographic projections are truly 3D with all human depth cues (e.g., stereopsis, motion parallax, and ocular accommodation). These projections provide realism and facilitate more intuitive understanding. Holographic images may be viewed simultaneously from different positions by different viewers. Due to increased computational power, high-performance holographic video displays, and improved compression, real time generation and display of holographic images may be provided.

Manipulation of holographic projections is provided by sensing an object interacting with the holographic image. Gesture recognition systems and voice commands may be used to manipulate the holographic image in general ways (e.g., resize or translate). For higher precision interaction with the holographic image, the user easily perceives any misregistration between the physical and virtual spaces. Even with calibration, such misregistration often occurs.

### BRIEF SUMMARY

By way of introduction, the preferred embodiments described below include methods, systems, instructions, and computer readable media for registration of an object or haptic device with a holograph. The position of the object or haptic device relative to the projector or holographic image is sensed. An eye tracking system acts as an additional source of information about the position. As a viewer interacts with the holograph, their eyes focus on the location of interaction. The eye tracking, such as the focal location, provides an additional source of position information to reduce or avoid misregistration.

In a first aspect, a method is provided for registration of a haptic device with a holograph. A projector generates a holographic image. A focal point of eyes of a viewer of the holographic image is determined. A position of the haptic device relative to the holographic image is registered as a function of the focal point. An indication of interaction of the haptic device with the holographic image output. The indication is responsive to the position.

In a second aspect, a system is provided for registration of an object with a holographic image. A projector is configured to generate the holographic image. A sensor is configured to sense a first position of the object relative to the holographic image. An eye tracker is configured to determine a view characteristic of a viewer of the holographic image. A processor is configured to determine a second position of the object relative to the holographic image from the view characteristic and to generate an output as a function of the first and second positions.

In a third aspect, a method is provided for registration of a haptic device with a holograph. A holographic image is presented. Interaction of the haptic device with the holographic image is modeled with eye tracking of an operator of the haptic device.

The present invention is defined by the following claims, and nothing in this section should be taken as a limitation on those claims. Further aspects and advantages of the invention are discussed below in conjunction with the preferred embodiments and may be later claimed independently or in combination.

### BRIEF DESCRIPTION OF THE DRAWINGS

The components and the figures are not necessarily to scale, emphasis instead being placed upon illustrating the principles of the invention. Moreover, in the figures, like reference numerals designate corresponding parts throughout the different views.

FIG. 1 is a flow chart diagram of one embodiment of a method for registration of a haptic device with a holograph;

FIG. 2 shows an embodiment of a system for registration of a haptic device with a holograph; and

FIG. 3 is a block diagram of another embodiment of a system for registration of a haptic device with a holograph.

### DETAILED DESCRIPTION OF THE DRAWINGS AND PRESENTLY PREFERRED EMBODIMENTS

A haptic device for holographic image exploration and/or manipulation is integrated with an eye tracking system. Haptic devices, such a stylus, scalpel, or needle, may be used for holographic image interactions that require complex high precision maneuvers like actions used during preoperative planning procedures. Similarly, a finger or other object may be used. The haptic device or object and eye-tracking are used together to provide a more seamless user interaction with holographic images.

In one example embodiment, both a holographic image projection system as well as a haptic system receive as input the same 3D model. As the user moves the haptic device, a collision engine detects the intersection of the device with the holographic projection of the 3D model and some sort or sensory feedback is generated. Due to calibration, the haptic system and holographic image projection are spatially registered. The success of this system relies heavily on the registration, but there may be some misalignment. The disparity between the two modalities may become obvious to the user unless the two systems are carefully co-registered so that the user perceives a single integrated system. Accurate registration between these two worlds is a difficult problem due to the complexity of the holographic image projection. By detecting the user's focus point or other view characteristic using an eye tracking system, extra information is used to solve any ambiguity and/or improve any misalignments in the registration.

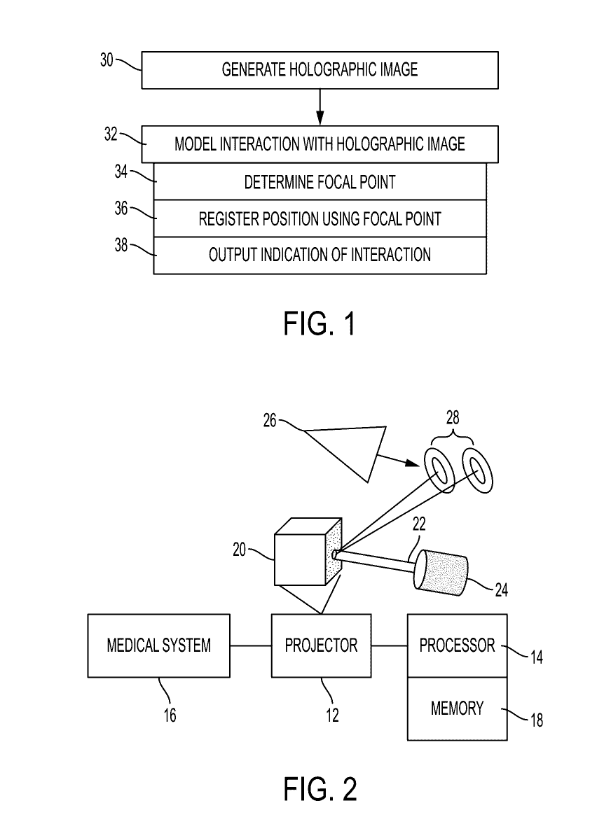

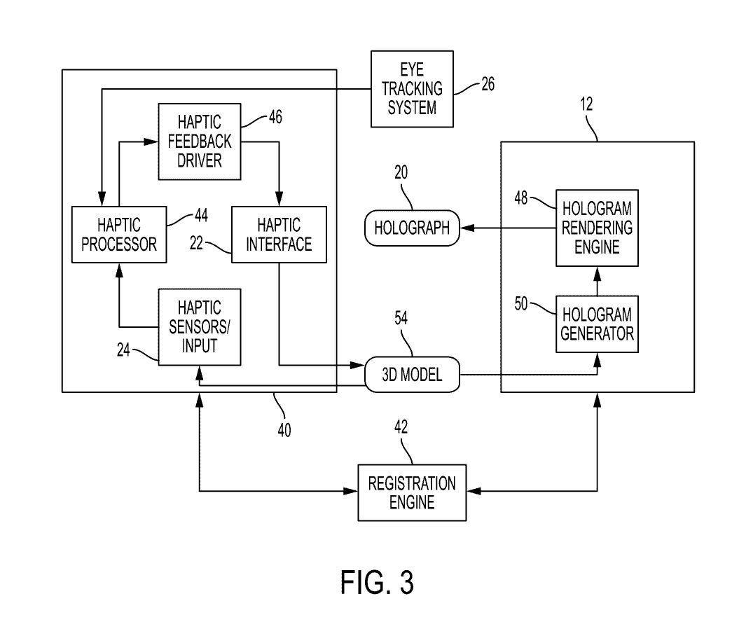

FIG. 1 shows a method for registration of a haptic device with a holograph. The method is performed by the system of FIG. 2, the system of FIG. 3, a processor, a medical imaging system, a holograph system, an eye tracking system, a haptic system, or combinations thereof. For example, a holographic system performs act 30 and may perform, at least in part, act 38. An eye tracking system performs act 34, and a processor of a computer in any of the other systems or as a stand-alone device performs act 36.

The method is performed in the order shown or a different order. Additional, different, or fewer acts may be provided. For example, acts 34-38 represent one example for providing act 32, but other examples with or without any of acts 34-38 may be provided. As another example, acts (e.g., user input) for controlling (e.g., scaling, translating, and/or orienting) the generation of the holographic image are provided. In another example, repetition of any of the acts, such as performing all of the acts repetitively in sequence for multiple interactions or interactions from multiple viewers is provided. Acts for calibrating the registration or coordinate transform of the projector and the haptic device may be provided.

In general, the method is directed to the viewer interacting with a holograph. To guide the location of interaction more accurately, eye tracking of the viewer is combined with any other sensing of the position and/or orientation of the haptic device or object.

In act 30, a holographic image is presented. A projector generates the holographic image. Any now known or later developed holographic image presentation may be used. For example, any volumetric or real 3D display for displaying the image in three full dimensions may be used. A volumetric display, such as a multi-planar stack or rotating panel display may be used. Multi-directional backlighting, light dot projection with a laser, or other holographic display may be used. In one embodiment, an interference pattern of coherent light is used.

The projector is one or more lasers or other light sources. The projection may be to air or to an object that is part of the holographic system. In one embodiment, the projector is part of a portable computing device, such as a tablet or smart phone. Since the projected image may be at any scale relative to the projector, a smaller device may project an image several times the size of the projecting device.

The holographic image is generated from a 3D model. Data representing a 3D surface or 3D volume is used to render the holographic image. A frame of data with different intensities and/or colors for different voxels is rendered as the holographic image. In one example, medical scan data is used. Computed tomography (CT), magnetic resonance (MR), ultrasound, positron emission tomography (PET), single photon emission computed tomography (SPECT), or other medical scan modality acquires data representing part or all of a patient. The medical scan data represents a 3D region or portion of the patient. Image processing may be applied to segment the data. For example, the 3D region includes a heart or other organ of interest, but also includes other tissue. This other tissue information is removed for generating the holographic image. Alternatively, other information (e.g., other organs) are included, but colored or displayed differently. In other examples, the 3D model is of other objects, such as an engineered object (e.g., a device being designed, maintained, or serviced).

In act 32, interaction with the holographic image is modeled. Any interaction may be modeled. For example, the modeling provides for haptic feedback to emulate resistance, contact, or other interaction of an object with the holographic image. This interaction provides greater reality to the holographic image by adding the sense of feel. As the user positions an object against, at, or through part of the holographic image, haptic feedback is provided. In another example, the interaction is to manipulate the holographic image. The manipulation may be to alter the rendering, such as changing scale, position, or orientation. By pushing on the holographic image at a given location or locations with the object, the interaction is translated into a change in the rendering (e.g., spinning or re-orienting the holographic image due to application of a shear motion to a surface represented in the holographic image). In yet another example, the manipulation changes the 3D model. The change may be in segmentation or color, such as coloring a part, segment, line, surface, or point differently to indicate selection associated with a location of an object. The change may be in the shape of the 3D model, such as representing making a cut, puncture, or other alteration of the object represented by the 3D model. The change may emulate therapy effects, surgical effects, redesign effects, or other effects.

The interaction is of an object with the holographic image. The object may be part of the viewer, such as the viewer's finger or hand. The object may be a haptic device, such as a pointer, scalpel, clamp, or other handheld tool. The object may be robotic, such as a robot arm controlled by the viewer.

For the interaction, the position of the object, such as the haptic device, is registered relative to the holographic image. The position may be of a point, line, area or volume of the object. For example, the location (e.g., relative translation), orientation (e.g., relative rotation), and/or scale (e.g., relative size) are registered for the entire object or an arm/finger of the object. By knowing the position of the object and the position of the holographic image, the collusion or other interaction of the object with the holographic image is detected.

Acts 34, 36, and 38 represent one embodiment of modeling the interaction of the object with the holographic image. Other embodiments using additional, different, or fewer acts may be provided.

In act 34, at least some registration information is acquired by eye tracking. The position of the haptic device or other object is determined, in part or total, from eye tracking. The position is in 3D space. By calibration of the eye tracking to the holographic projection system, the registration information from the eye tracking is a position relative to the holographic image.

For eye tracking, eye position and/or eye movement is measured. A camera or cameras are used for video-based tracking, but search coils or electrooculograms may be used. In one embodiment, the center of the pupil is determined from an image of the view. In combination with infrared or near-infrared non-collimated light to create corneal reflections, a vector between the pupil center and the corneal reflection indicates the gaze direction. Passive light may be used. Head-mounted, remote, or other eye tracking systems may be used.

Any characteristic is determined. For example, an intersection or point of minimum distance between the vectors from both eyes indicates a focal point of the eyes of the viewer. The view direction, such as an average of the vectors from both eyes, may be used. Other characteristics may be determined by the eye tracking system.

The characteristic is determined while the viewer is holding the haptic device or using an object to interact with the holographic image. For example, the focal point of the viewer is determined while the viewer is holding the haptic device for interaction. Since the haptic device is being used to interact, the viewer is likely focusing on the location or point in three dimensions of the interaction (i.e., point of interaction between the haptic device and the holographic image).

The characteristic is determined for a given instant in time. The determination may be repeated. In other embodiments, the determination is repeated and the average of the characteristic is calculated in a moving time window. Low pass or other filtering of the characteristic may be used.

In act 36, the position of the object is registered to the holographic image using the determined characteristic, such as the focal point. The characteristic indicates a 3D point location, a line, a region, or other spatial limitation. The position information may be inclusive, such as the viewing direction being along a line or at a focal point. The position information may be exclusive, such as the vision being directed to a conical region and not elsewhere. Similarly, the position information may indicate location (e.g., translation), orientation, and/or scale.

The position information is used to register. In one embodiment, the eye tracking system is also used to image the holographic image so that the determined eye tracking characteristic has a known spatial location relative to the holographic image. In other embodiments, the eye tracking system is calibrated to the holographic projector so that the characteristic of the viewers viewing of the haptic device or holographic image has a spatial position relative to the holographic image. The calibration provides a spatial transform relating the eye tracked characteristic to the holographic image.

The haptic device or object is treated as having a given relationship to the characteristic. For example, the focal point of the viewer is treated as being an end point of a pointer or tool. As another example, a viewing direction of the viewer is treated as intersecting the endpoint of the haptic device. In yet another example, the viewing region is treated as including the haptic device. The position of the haptic device or other object is registered relative to the holographic image using the characteristic. Other registration approaches may be used.

Other position information may be used with the eye tracked characteristics. The haptic device or object may include or be sensed by other sensors. Optical, ultrasound, radio frequency, electric field, or other position sensing devices may be used. For example, the haptic device includes different sets of orthogonal coils. Signals generated on the coils in response to a magnetic field generated by an antenna at a given location indicate the location and/or orientation of each of the sets of coils. As another example; an array of cameras uses triangulation or other processing to determine the position of the object in 3D space. Any now known or later developed position sensing may be used.

The haptic or object sensing is calibrated with the holographic projector. The calibration provides a transform of spatial coordinates between the projector and the haptic sensing. The transform is used to register the sensed position of the object with the holographic image.

The position of the haptic device or other location is used in combination with the position determined by eye tracking. The haptic device sensing may provide the location and orientation. The focal point or other characteristic indicates a location of part of the haptic device or object. The location as sensed by the haptic device sensors may be adjusted (e.g., translated) to position a given point (e.g., end or tool interaction location) at the focal point, within a region of viewing, or intersecting a view direction. The orientation as determined by the object sensing is maintained in the shift or changes to provide the shift. The object may be positioned such that the point on the object is at an average location. Any function combining the position information from different sources may be used.

In another embodiment, a difference in position is determined. If the difference is below a threshold, then the position information from the eye tracking is used with the position information from the haptic device sensing. If the difference is above a threshold, then an error signal and/or instructions to re-calibrate may be sent or measurements repeated until the difference is within the threshold. Different ranges of difference may be provided, such as one range indicating use of only the haptic sensing position, another range indicating a position that is a combination of the eye tracked position and the object sensed position, and yet another range for indicating an error.

In act 38, an indication of the interaction is output. The interaction of the object, such as the haptic device, with the holographic image is indicated to the viewer or viewers.

The indication is output as part of the holographic image. The holographic image is changed. Due to the interaction, the 3D model or rendering of the 3D model is altered to account for the interaction. Color, position (e.g., location, orientation, and/or scale), shape, or other alteration is reflected in the holographic image. For example, the interaction models cutting, puncturing, or other medical activity. The 3D model is altered to show the results of the medical activity. As another example, a part of the 3D model to be segmented away is defined, at least in part, by the interaction. The color of the tissue for that segment is altered or the tissue for that segment (e.g., organ) is removed (e.g., segmented or masked). This change is reflected in the 3D model and resulting rendering in the holographic image. Graphics for tools or user interface information may be presented with, on, or as part of the holographic image in response to the interaction. Other alterations in response to the interaction may be visually indicated in or by the holographic image.

In other embodiments, the indication is not visual or also includes non-visual indication. Instead, the indication is communicated through smell, feel, hearing, other sense, or combinations thereof. For example, the interaction may result in a sound. As the haptic device contacts a surface represented in the holographic image, a sound is generated. For undesired contact in planning or practicing surgery, the sound may be a warning. For other contact, the sound may emulate a sound heard during surgery.

Another non-visual indication is haptic or force feedback. The indication is output as haptic feedback to be sensed by feel. Vibration, air blast, shock, or other technique for communicating to the viewer through feel may be used. For example, as the user emulates cutting tissue represented on the holographic image, slight vibration may be added to the haptic device to indicate the interaction of the haptic device with the holographic image. Any now known or later developed haptic feedback may be used.

The indication may vary based on the 3D model, position, or other consideration. For example, different indications are provided for different types of interaction (e.g., cutting, segmenting, or pointing). In one embodiment, the haptic feedback varies as a function of the type of material or tissue represented in the holographic image. As a collision between the haptic device and the object as represented in the holographic image is detected, different tactile responses are generated depending on the type of tissue or material represented at that location. The viewer receives different tactile feedback depending on whether the viewer is emulating “touching” bones or soft tissue. The amplitude, frequency, color, size, or other aspect of the indication is different for different materials or objects.

The position of part of the entire haptic device or object determines the indication. If the position is spaced from the representation of the 3D model in the holographic image, then no indication is output. Upon contact or position indicating the haptic device or object colliding with the representation of the 3D model in the holographic image, the indication is output. As the object or haptic device is inserted further into or moved within the holographic image, further, different, or continuing indication may be output.

The indication is output in response to the position of the object or haptic device. The position at a time of activation is used. For example, the viewer depresses a button on the haptic device, the holographic projector, or other device to indicate or activate interaction. The position of the haptic device as the time of selection is determined. Alternatively, the position is monitored or regularly updated and the interaction results from the position without additional viewer input.

The indication may be different for different positions and/or activations. The position may indicate a particular material or tissue represented in the 3D model, so a corresponding indication appropriate for that material or tissue is output. The force feedback, color, or alteration may be different for different tissues or materials. In one example, the position over time indicates a location of a cut. The 3D model alters to show that cut over the line or curve traced by the position. In another example, activation or selection graphics are provided in the holographic image. By positioning the object at one of the graphics or icons, the viewer indicates the type of operation to emulate. After the selection of the type of operation, the indication appropriate for that operation based on the position of the object against or in the representation of the 3D model in the holographic image is output. For example, the user selects a “stent” tool by activating when a tip of the haptic device is at a “stent” tool graphic in the holographic image. The user then activates the haptic tool when the tip is within the 3D model of a vessel of the holographic image. The 3D model is altered to remove a restriction in flow or to increase a vessel diameter at the location or in a region centered at the location of the tip when activated. Position of the haptic device over time or between activations may be used to define a range over which change is to occur.

The object is positioned relative to the holographic image and corresponding projector. The position of the object relative to the image is determined with eye tracking. Other position sensors may also be used. The position of the object or part of the object (e.g., tip of a pointer) is used to determine an interaction. In response to the positioning, an indication of alteration or other interaction is output to the viewer. The use of eye tracking position may result in more accurate positioning for use with any type of interaction of the viewer with the holographic image.

FIG. 2 shows a system of one embodiment for registration of an object with a holographic image. The object is part of the viewer, such as a hand or finger, or is a haptic device held or controlled by the viewer. For example, the object is an implement (e.g., tool or pointer). Alternatively, the object may be a robot controlled by the viewer.

The system implements the method of FIG. 1 or a different method. For example, the eye tracking system 26 implements act 34. The projector implements act 30, and the processor 14 implements acts 36 and 38. Other components or combinations of components may implement different acts.

The system includes a projector 12, a processor 14, a medical system 16, a memory 18, a haptic device 22, a sensor 24 of the haptic device 22, and the eye tracking system 26. Additional, different, or fewer components may be provided. For example, the medical imaging system 16 is not provided. Instead, the 3D model used by the projector 12 is stored in the memory 18 or provided from another source. As another example, the haptic device 22 and/or the sensor 24 are not provided and a hand of the viewer is used instead. FIG. 3 shows another embodiment of the system for registration of an object with a holographic image with additional components. Other systems with more or fewer components may be provided.

The projector 12 is a light source or laser. Infrared or other light wavelengths may be used. An array for coherent light generation in a pattern in 3D space may be used. Any now known or later developed holographic projector may be used.

The projector 12 is mounted and/or positioned in a room or by a workstation. For example, a room dedicated to holographic projection has the projector 12 mounted to a ceiling, wall, and/or floor. Alternatively, the projector 12 is incorporated into a mobile device, such as a wheeled cart or handheld phone or tablet.

In the embodiment of FIG. 3, the projector 12 includes a holograph generator 50 that receives the 3D model 54. Based on the rendering by the hologram rendering engine 48, such as a processor or graphics processing unit, the projector 12 presents the holographic image 20 as generated by the generator 50. This projector system may be a holograph projector system available as an independent system for any holograph generation use. Alternatively, a projector 12 or projection system integrated and/or designed specifically for the overall system of FIG. 2 or 3 is used.

The projector 12 is configured to generate a holograph 20 in 3D space. A renderer of the holographic projection system renders a 3D model, which the projector 12 then projects. Any 3D model may be used, such as medical scan data representing a patient. The medical scan data includes voxel values. The 3D model is of a 3D surface (e.g., surface of an organ extracted from medical scan data) or volume representation of a patient. Other 3D models may be used.

The medical system 16 is any now known or later developed medical imaging system or scanner. For example, the medical system 16 is a CT or other x-ray system (e.g., fluoroscopic). An x-ray source and detector are positioned opposite each other and adjacent to a patient and may be moved about the patient for scanning. In one embodiment, the medical system 16 is a spiral or C-arm CT system. In other examples, the medical system 16 is a MR, PET, ultrasound, SPECT, or other imaging system for scanning a patient.

The medical system 16 is configured by stored settings and/or by user selected settings to scan a patient. The scan occurs by transmitting and receiving or by receiving alone. By positioning relative to the patient, aiming, and/or detecting, the patient is scanned. The scan data resulting from the scan may be reconstructed, image processed, rendered, or otherwise processed to show an image and/or calculate a characteristic of the patient.

The eye tracker 26 is one or more cameras. A light source, such as an infrared or near-infrared source, may be used to directing non-collimated light at the eyes 28 of the viewer. Visible light may be used. The eye tracker 26 may be head mounted or positioned in a room but spaced from the viewer. Any now known or later developed eye tracking system may be used.

In other embodiments, the eye tracker 26 includes a processor, circuit, or other system components for deriving a view characteristic of the viewer from the output of the cameras. For example, a focal position and/or view direction are determined. Any view characteristics of the viewer of the holographic image may be determined by the eye tracker 26. In alternative embodiments, the eye tracker 26 does not include a processor or other components for deriving view characteristic. Instead, the image or video output of the eye tracker 26 is used by other devices to derive the view characteristic.

The haptic device 22 is a pointer, tool, or other implement. The haptic device 22 is shaped and sized to be hand held. In alternative embodiments, the haptic device 22 is a robot or other user-controllable and moveable device. In yet other embodiments, the viewer's hand or other body part is used as the haptic device 22. The haptic device 22 is a device positionable in 3D space relative to the holographic image 20.

The sensor 24 connects with the haptic device 22. Alternatively, the sensor 24 is separate from and/or spaced from the haptic device 22. The sensor 24 is configured to sense a position of the haptic device 22 relative to the holographic image. The position is sensed as a 3D location and/or orientation of the haptic device 22. The overall position or the position of part of the haptic device 22 is sensed, such as sensing a location of the tip or a location of a tip and orientation of the entire haptic device 22.

The sensor 24 is a magnetic position sensor, camera or optical position sensor, ultrasound position sensor, or any other now known or later developed position sensor. The sensor 24 may include antennas or emitters at one or more locations on the haptic device 22 and/or spaced from the haptic device 22. For example, the cameras of the eye tracker 26 and/or different cameras at different positions relative to the viewer capture the haptic device 22 and determine the 3D position. As another example, receivers and/or transmitters on the haptic device 22 operate with transmitters and/or receivers spaced from the haptic device 22 to determine the position from time of flight, magnetic field measurements, or other information. Only one sensor 24 is used, or a plurality of the same or different types of sensors 24 are used together to measure the position.

The sensor 24 is calibrated relative to the projector 12. The calibration registers the coordinate system of the sensor 24 with the coordinate system of the projector 12. Any calibration procedure may be used, such as positioning the haptic device 22 at three or more different projected points from the projector 12 and measuring the position. Based on this calibration, the measured position of the haptic device 22 by the sensor 24 is related to locations in the field of view or projection of the projector 12. As represented in FIG. 3, the haptic system 40 may receive and use the 3D model 54 for registration or calibration. The eye tracker 26 may be calibrated in a same way by directing the viewer to focus or look at particular projected points.

The haptic device 22 and sensor 24 are part of a haptic system separate from or integrated with the holographic projection system. For example, FIG. 3 shows one embodiment where the haptic system 40 includes the sensor 24, the haptic device 22, a feedback driver 46 for haptic feedback to the viewer and/or haptic device 22, and/or a haptic processor 44. The feedback driver 46 is a vibrator, air source, or other tactile generating device. In alternative embodiments, the sensor 24 and/or haptic device 22 are provided without the feedback driver 46 and/or haptic processor 44. This haptic system may be a haptic system available as an independent system for any haptic sensing use. Alternatively, the haptic sensor 24, haptic device 22, or haptic system is integrated and/or designed specifically for the overall system of FIG. 2 or 3.

Referring again to FIG. 2, the processor 14 and/or memory 18 are part of a computer, server, workstation, or other processing device. In the embodiment of FIG. 2, the processor 14 and memory 18 are separate from the haptic system, projector system, and eye tracking system. Wired or wireless communications are used to interact between the systems so that the processor 14 may determine position of the haptic device 22 relative to the projection 20 and/or cause output indicating the interaction. In other embodiments, the processor 14 and/or memory 18 are part of any one or more of the component systems, such as being part of the projector, haptic, and/or eye tracking systems.

The processor 20 is a general processor, central processing unit, control processor, graphics processor, digital signal processor, three-dimensional rendering processor, image processor, application specific integrated circuit, field programmable gate array, digital circuit, analog circuit, combinations thereof, or other now known or later developed device. The processor 20 is a single device or multiple devices operating in serial, parallel, or separately. The processor 20 may be a main processor of a computer, such as a laptop or desktop computer, or may be a processor for handling some tasks in a larger system, such as in the medical imaging system 16, eye tracking system, haptic system, or projector system. The processor 20 is configured by instructions, design, firmware, hardware, and/or software to perform the acts discussed herein.

The processor 14 is configured to determine a position of the haptic device 22 or other object. The position is determined relative to the holographic image 20. The position is based on a registration of the haptic device 22 or coordinate system of the haptic system 40 with the holographic image 20 or coordinate system of the projector 12 or projector system. This registration is represented by the registration engine 42 in FIG. 3. The coordinate systems are aligned or registered. As a result, a sensed position of the haptic device 22 by the haptic sensor 24 registers the haptic device 22 relative to the holographic image 20.

To refine or replace the registration, position information from eye tracking is used. The processor 14 uses one or more sources of position information for registration. The position of the haptic device 22 is determined from measurements by the sensors 24 and/or eye tracking system 26. For example, the eye tracking system 26 outputs to the processor 14 a view characteristic, such as a focal point. The sensors 24 output to the processor 14 (e.g., haptic processor 44) the sensed position or measures for determining position. Based on these multiple sources of position information, the processor 14 determines the location and/or orientation of the haptic device 22 in the 3D space of the holographic image 20. Any function may be used to combine position information from different sources to solve for a given position of the haptic device 22 at a given time. For example, an average position is found from the position indicated by the sensors 24 and the position indicated by the eye tracker 26.

The processor 14 is configured to generate an output using the position or positions. The output is haptic feedback. For example, the position of the haptic device 22 relative to the holographic image 20 indicates collision. As a result, the processor 14 controls the haptic feedback driver 46 to vibrate, blow air, or cause other feedback for the viewer to feel. Sound, smell, or other output may be provided instead or in addition to haptic feedback.

The output is alternatively or additionally visual. The 3D model 54 and/or the holographic image 20 representing the 3D model is altered. The alteration may be in color, shape, intensity, or other characteristic. The processor 14 controls the 3D model 54, the hologram generator 50, and/or rendering engine 48 of the projector 12 to cause implementation of the alteration.

The output depends on the position. Different outputs are provided for different positions. No output (e.g., no haptic feedback and/or no visual alteration) may be provided for some positions. If the haptic device 22 is at other positions, then a corresponding output is selected. Different levels of outputs, types of outputs, or combinations of outputs may be provided for different locations. For example, the processor 14 causes haptic feedback and visual deformation of the surface of the 3D model as displayed in the holographic image 20 as the haptic device 22 moves past initial contact with a surface represented in the holographic image 20. The output occurs where the position is at, at a region around, or by the border represented in the holographic image 20.

The output may additionally or alternatively be different depending on the type of interaction and/or tool selection. The direction and/or rate of motion may determine the type of interaction. Selection based on activation on holographic icons, user button selection on a keyboard or the haptic device 22, or other selection may determine the type of interaction.

The processor 14 may output an error signal. Where the position of the haptic device 22 as sensed by the sensors 24 is different or different by a threshold distance, the processor 14 outputs an error signal. The error signal indicates that calibration between the haptic system and the holographic projector system is to be repeated.

The memory 18 is a graphics processing memory, video random access memory, random access memory, system memory, cache memory, hard drive, optical media, magnetic media, flash drive, buffer, database, combinations thereof, or other now known or later developed memory device for storing a 3D model, positions, position measurements (e.g., sensor output), and/or other information. The memory 18 is part of the imaging system 16, a computer associated with the processor 14, the haptic system 40, the projector 12, the eye tracking system 26, a database, another system, a picture archival memory, or a standalone device.

The memory 18 or other memory is alternatively or additionally a computer readable storage medium storing data representing instructions executable by the programmed processor 14 or other processor. The instructions for implementing the processes, methods, acts, and/or techniques discussed herein are provided on non-transitory computer-readable storage media or memories, such as a cache, buffer, RAM, removable media, hard drive or other computer readable storage media. Non-transitory computer readable storage media include various types of volatile and nonvolatile storage media. The functions, acts or tasks illustrated in the figures or described herein are executed in response to one or more sets of instructions stored in or on computer readable storage media. The functions, acts, or tasks are independent of the particular type of instructions set, storage media, processor or processing strategy and may be performed by software, hardware, integrated circuits, firmware, micro code and the like, operating alone, or in combination. Likewise, processing strategies may include multiprocessing, multitasking, parallel processing, and the like.

In one embodiment, the instructions are stored on a removable media device for reading by local or remote systems. In other embodiments, the instructions are stored in a remote location for transfer through a computer network or over telephone lines. In yet other embodiments, the instructions are stored within a given computer, CPU, GPU, or system.

While the invention has been described above by reference to various embodiments, it should be understood that many changes and modifications can be made without departing from the scope of the invention. It is therefore intended that the foregoing detailed description be regarded as illustrative rather than limiting, and that it be understood that it is the following claims, including all equivalents, that are intended to define the spirit and scope of this invention.

I (we) claim:

1. A method for registration of a haptic device with a holograph, the method comprising:
generating, with a projector, a holographic image;
determining a focal point of eyes of a viewer of the holographic image;
registering a position of the haptic device relative to the holographic image as a function of the focal point; and
outputting an indication of interaction of the haptic device with the holographic image, the indication being responsive to the position.

2. The method of claim 1 wherein generating comprises generating from a three-dimensional model.

3. The method of claim 1 wherein generating comprises generating from medical scan data, the holographic image representing a three-dimensional portion of a patient.

4. The method of claim 1 wherein generating the holographic image comprises generating with the projector being part of a portable computing device.

5. The method of claim 1 wherein determining comprises determining the focal point of the viewer while the viewer is holding the haptic device.

6. The method of claim 1 wherein determining comprises determining with an eye tracking system.

7. The method of claim 1 wherein registering comprises sensing a location of the haptic device and determining the position as a function of the location and the focal point.

8. The method of claim 1 wherein outputting comprises outputting the indication as haptic feedback to the haptic device, the haptic feedback being in response to the position of the haptic device interacting with the holographic image.

9. The method of claim 8 wherein outputting the haptic feedback comprises outputting the haptic feedback as a function of a type of material or tissue represented in the holographic image at the position.

10. The method of claim 1 wherein outputting comprises outputting the indication as an alteration of the holographic image, the alteration being in response to the position of the haptic device relative to the holographic image.

11. A system for registration of an object with a holographic image, the system comprising:
a projector configured to generate the holographic image;
a sensor configured to sense a first position of the object relative to the holographic image;
an eye tracker configured to determine a view characteristic of a viewer of the holographic image; and
a processor configured to determine a second position of the object relative to the holographic image from the view characteristic and to generate an output as a function of the first and second positions.

12. The system of claim 11 wherein the projector comprises a renderer configured to render from medical scan data.

13. The system of claim 11 wherein the sensor comprises a sensor configured to sense the first position and orientation of the object.

14. The system of claim 11 wherein the object comprises part of the viewer.

15. The system of claim 11 wherein the object comprises an implement held by the viewer.

16. The system of claim 11 wherein the eye tracker is configured to determine a focal point of the viewer as the view characteristic, and wherein the processor is configured to determine the second position as the focal point.

17. The system of claim 11 wherein the processor is configured to generate the output based on an average of the first and second positions, the output comprising an alteration of the holographic image at the average of the first and second positions or haptic feedback where the average of the first and second positions is at a border represented in the holographic image.

18. The system of claim 11 wherein the processor is configured to generate the output as an error signal

19. A method for registration of a haptic device with a holograph, the method comprising:
presenting a holographic image; and
modeling interaction of the haptic device with the holographic image with eye tracking of an operator of the haptic device.

20. The method of claim 19 wherein modeling comprises registering a position of the haptic device relative to the holographic image as a focal point from the eye tracking.
